(19) United States
(12) Patent Application Publication
(10) Pub. No.: US 2026/0257523 A1
(43) Pub. Date: Sep. 3, 2026

(54) TRAILER COUPLER LOCK SYSTEM WITH INTERCHANGEABLE ADAPTER AND GRAVITY-ACTUATED COUPLER ENGAGEMENT

(71) Applicant: DYNAMIC MANUFACTURING GROUP LLC, PALMETTO, FL (US)

(72) Inventors: Ronald Lee, II, Ruskin, FL (US); Anthony Sansone, Parrish, FL (US); Bradly Martin, Sarasota, FL (US)

(21) Appl. No.: 19/655,519

(22) Filed: Apr. 22, 2026

Related U.S. Application Data
(63) Continuation-in-part of application No. 18/465,104, filed on Sep. 11, 2023, now Pat. No. 12,623,499.

(51) Int. Cl. B60D 1/60

(52) U.S. Cl. CPC B60D 1/60

(57) ABSTRACT

A trailer coupler lock system includes an outer shell, an interchangeable adapter received in an adapter slot, and a receptacle-engaging device movable within a vertical plug channel. In the locked state, the device extends through an opening in the adapter base and into the coupler’s ball-shaped cavity, preventing removal of both the adapter and shell without requiring them to be fastened together. The engaging device may be a gravity-actuated plug with an elongated slot and locking recess, or a spring-biased pin assembly with a pin body, coaxial neck, compression spring, and slidable cap. Both embodiments require key actuation to unlock. The spring-biased version further allows tool-free adapter exchange by simple digital depression of the cap. The shell exterior incorporates hexagonal prism bosses in a honeycomb pattern to resist angle-grinder attack.

### CROSS-REFERENCE TO RELATED APPLICATIONS

This application is a Continuation-In-Part of U.S. Patent Application No. 18/465,104, filed September 11, 2023, which is incorporated herein by reference in its entirety.

### FIELD OF THE INVENTION

This invention relates to security devices for trailer couplers, and more particularly to a multi-component trailer coupler lock system comprising a protective outer shell, an interchangeable adapter, and a receptacle engaging device that cooperate to prevent removal of the lock from a trailer coupler without requiring the adapter and shell to be mechanically fastened to one another.

### BACKGROUND OF THE INVENTION

Trailers used in commercial, recreational, and agricultural applications are vulnerable to theft when left unattended. A common method of theft involves attaching an unauthorized towing vehicle to an unattended trailer by coupling it to the trailer’s ball-and-socket hitch coupler. Conventional trailer coupler locks have been developed to prevent such unauthorized coupling, but they suffer from numerous shortcomings that limit their effectiveness, versatility, and resistance to attack.

Conventional coupler locks typically comprise a one-piece housing designed to fit a single coupler size. Because trailer couplers are manufactured in multiple sizes—most commonly to receive towing balls of 1-7/8 inch, 2 inch, 2-5/16 inch, and 3 inch diameter—a separate lock must ordinarily be purchased for each coupler configuration. This lack of universality imposes unnecessary cost and inconvenience on the consumer.

Even among locks claiming interchangeability, the prior art generally relies upon adapters that are mechanically fastened to the lock body by screws, bolts, clips, or other hardware. Such fastening arrangements require tools for installation and removal, create additional failure points, and introduce surfaces that can be attacked by cutting tools or pry bars. Moreover, when the adapter must be fastened to the shell to function, the time and complexity of adapter exchange increases significantly, reducing the practical utility of the interchangeability feature.

Prior art solutions such as those described in Cato et al. (U.S. 11,766,905 and U.S. 2025/0018754) disclose modular coupler locks in which adapters are configured to be received in a universal cavity within a lock body. However, such prior art designs do not disclose or suggest a system in which the adapter and shell are held in a locked assembly on the coupler solely by the action of a vertically movable receptacle engaging device that, in its locked position, extends through the adapter and into the receptacle cavity of the coupler, without any requirement that the adapter and shell be fastened to one another. The Cato prior art, in particular, describes adapters that fasten to the lock body, and discloses an arrangement in which the primary purpose is to secure the coupler to the vehicle rather than to prevent removal of the lock from the coupler while the trailer is unattended.

Other prior art, including Tsai (U.S. 2020/0023698) and Jacques (U.S. 2006/0163842), discloses clamping-type and rotating cam-type mechanisms that differ fundamentally from the slide-in adapter and vertically actuated plug architecture of the present invention. These references fail to suggest a system in which three components—an outer shell, a non-fastened adapter, and a vertically movable receptacle engaging device—cooperate to prevent the shell from being removed from the coupler.

The exterior surfaces of prior art locks are generally smooth or finned, presenting surfaces susceptible to continuous engagement by cutting tools such as angle grinders. A lock body whose exterior geometry is configured to defeat angle grinder attack by causing the cutting disc to skip, chatter, or fail to maintain continuous contact represents a distinct advancement over the prior art.

Exchanging adapters in prior art interchangeable lock systems requires the use of tools and multiple steps, including loosening a set screw, sliding out a sleeve, and physically extracting the receptacle engaging device from the plug channel before the adapter can be removed. This multi-step, tool-dependent process makes routine adapter exchange cumbersome and impractical in the field. There remains a need for a receptacle engaging device that, once the locking bolt has been retracted by key actuation, allows the adapter to be exchanged by simple manual depression of a spring-loaded element without the need for tools, without removal of the receptacle engaging device from the plug channel, and without loosening of the set screw.

Accordingly, there is a need in the art for a trailer coupler lock that is compatible with a range of coupler sizes through the use of interchangeable adapters that do not require fastening to the shell, that secures the assembly to the coupler through a gravity-actuated or spring-biased receptacle engaging device, and that resists both physical attack and unauthorized removal. The invention is directed to overcoming one or more of the problems and solving one or more of the needs as set forth above.

### SUMMARY OF THE INVENTION

It is an object of the present invention to provide a trailer coupler lock system that prevents removal of the lock from a trailer coupler through the cooperative engagement of a protective outer shell, an interchangeable adapter, and a vertically movable receptacle engaging device, without requiring the adapter and shell to be mechanically fastened to one another.

It is a further object of the invention to provide a trailer coupler lock in which an adapter is removably received in an adapter engagement slot of the shell and is retained in the locked assembly solely by the extension of a receptacle engaging device through the adapter and into the ball-shaped cavity of the trailer coupler receptacle.

It is a further object of the invention to provide a trailer coupler lock system in which the receptacle engaging device is actuated by gravity, descending to its locked position when released, and is locked in that position by a bolt mechanism that engages a recess in the receptacle engaging device.

It is a further object of the invention to provide a trailer coupler lock system in which the receptacle engaging device is a spring-biased pin assembly comprising a pin body, a coaxial neck extending from the pin body, a coiled compression spring disposed over the neck, and a slidable cap retained on the neck by a snap ring, wherein the spring urges the cap to a full-length position that occupies the adapter base hole when the locking bolt has been retracted, and wherein manual digital depression of the cap to a compressed length permits adapter removal and installation without tools and without removal of the receptacle engaging device from the plug channel, the key advantage being the elimination of the tool-dependent steps required by the prior gravity-actuated plug design.

It is a further object of the invention to provide a trailer coupler lock system in which the shell includes an exterior surface formed with a plurality of hexagonal prism bosses arranged in a honeycomb pattern that resist cutting tool attack by presenting multiple angled surfaces to a cutting disc, causing the disc to skip or chatter rather than maintain continuous cutting contact.

It is a further object of the invention to provide a trailer coupler lock system in which an adapter includes a ramped surface that guides the flange of a trailer coupler receptacle onto an elevated portion of the adapter base, thereby minimizing vertical play between the flange and the adapter slot and improving the security of engagement.

It is a further object of the invention to provide a trailer coupler lock system in which the adapter may optionally include a cover configured to envelop the receptacle portion of the trailer coupler, protecting the receptacle from drilling and other forms of physical attack.

It is a further object of the invention to provide a trailer coupler lock system in which the shell may be comprised of a lightweight material such as an aluminum alloy and the adapter may be comprised of a denser and harder material such as a hardened and tempered steel alloy, combining security and weight reduction.

In an exemplary implementation of the invention, a trailer coupler lock system comprises a shell having a front, a back, a bottom, and a top, with a cove formed in the back of the shell comprising a concave recess into which a receptacle portion of a trailer coupler may be received, an adapter engagement slot formed in the back of the shell at the cove, and a first channel extending from the bottom of the shell to the cove. An adapter is removably received in the adapter engagement slot. The adapter includes a base with a hole that aligns with the first channel when the adapter is received in the engagement slot, and a coupler flange engagement slot defined by the base, a sidewall extending upwardly from the base, and a flange extending inwardly from the sidewall. A receptacle engaging device is movable in the first channel from an unlocked position to a locked position. In the locked position, a portion of the receptacle engaging device extends through the hole in the base of the adapter and into the cove. In the unlocked position, the receptacle engaging device does not extend through the hole in the base of the adapter and does not extend into the cove. The adapter and the shell are not required to be mechanically fastened to one another, and the prevention of removal of the shell from the coupler is achieved through the cooperative engagement of the outer shell, the adapter, and the receptacle engaging device.

In another embodiment, the receptacle engaging device is a spring-biased pin assembly comprising a pin body, a coaxial neck extending longitudinally from a shoulder of the pin body, an external annular groove formed near the distal end of the neck, a coiled compression spring slidably received over the neck, and a tubular cap fitted over the neck and spring, the cap including an internal annular flange defining a central opening through which the distal end of the neck extends, and a snap ring engaged in the annular groove on a side of the internal annular flange opposite the spring. The spring is disposed between the shoulder and the internal annular flange and urges the cap away from the shoulder to a full-length position. Once the locking bolt has been retracted by key actuation, digital depression of the cap toward the shoulder compresses the spring to a compressed length, permitting removal or installation of the adapter without tools and without removing the spring-biased pin assembly from the plug channel.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a perspective view of an exemplary trailer coupler lock system with a first interchangeable adapter installed on an A-frame trailer coupler in accordance with principles of the invention.

FIG. 2 is a perspective view of an exemplary trailer coupler lock system with a second interchangeable adapter installed on an A-frame trailer coupler, the second adapter including a cover over the receptacle, in accordance with principles of the invention.

FIG. 3 is a first perspective exploded view of an exemplary trailer coupler lock system with a first interchangeable adapter, showing the shell, adapter, plug, key, and lock assembly separated from the trailer coupler.

FIG. 4 is a second perspective exploded view of an exemplary trailer coupler lock system with a first interchangeable adapter, illustrating the internal plug channel, structural cell, and adapter engagement slot.

FIG. 5 is a perspective partially sectioned view of an exemplary trailer coupler lock system with a first interchangeable adapter installed on an A-frame trailer coupler, showing the plug in the locked position extending through the adapter and into the coupler receptacle.

FIG. 6 is a perspective partially sectioned view of an exemplary trailer coupler lock system with a second interchangeable adapter installed on an A-frame trailer coupler, showing the cover of the second adapter enveloping the coupler receptacle.

FIG. 7 is a perspective view of an exemplary first interchangeable adapter for the trailer coupler lock system, showing the base, sidewall, flange, ramp, elevated portion, hole, and coupler receptacle space.

FIG. 8 is a perspective section view of the first exemplary interchangeable adapter, revealing the interior geometry of the coupler flange engagement slot.

FIG. 9 is a perspective view of an exemplary second interchangeable adapter including a cover configured to envelop the trailer coupler receptacle.

FIG. 10 is a perspective section view of the second exemplary interchangeable adapter, revealing the interior geometry of the coupler flange engagement slot and the cover structure.

FIG. 11 is a first perspective section view of the exemplary shell, showing the cove sidewall, cove rim, overhang, adapter engagement slot, bottom surface, plug channel, lock channel, annular groove, and threaded set screw channel.

FIG. 12 is a second perspective section view of the exemplary shell, showing additional internal structural features including the plug channel, lock channel, overhang, and bottom surface of the cove.

FIG. 13 is a first perspective view of an exemplary locking sleeve of the bolt mechanism, showing the cylindrical bolt, window, and sleeve body.

FIG. 14 is a second perspective view of the exemplary locking sleeve, showing the narrow peripheral fenestration from an alternative angle.

FIG. 15 is a perspective view of the exemplary receptacle engaging device, showing the cylindrical body, elongated slot, and locking recess.

FIG. 16 is a perspective section view of the exemplary receptacle engaging device, further illustrating the elongated slot and locking recess geometry.

FIG. 17 is a rear perspective view of an exemplary trailer coupler lock system showing the shell with a first adapter secured in the adapter engagement slot by screws.

FIG. 18 is a rear perspective view of an exemplary trailer coupler lock system showing the adapter removed from the adapter engagement slot, the receptacle engaging device in the retracted unlocked position, and the screws removed, with the threaded holes in the adapter base and cove bottom surface visible.

FIG. 19 is a plan view of the exemplary first interchangeable adapter with certain dimensional references identified.

FIG. 20 is a back (rear) view of the exemplary first interchangeable adapter with certain dimensional references identified.

FIG. 21 is a plan view of an exemplary trailer coupler with certain dimensional references identified.

FIG. 22 is a side view of an exemplary trailer coupler with certain dimensional references identified.

FIG. 23 is a perspective exploded view of an exemplary spring-biased pin assembly for a trailer coupler lock system with an interchangeable adapter in accordance with principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

A trailer coupler lock system according to principles of the present invention comprises three cooperating principal components: a protective outer shell, an interchangeable adapter, and a receptacle engaging device. The cooperative engagement of these three components, together with the trailer coupler itself, results in a locked assembly from which the shell cannot be removed from the coupler without authorized actuation of the locking mechanism. A distinguishing feature of the present invention over the prior art is that the adapter and the shell are not required to be mechanically fastened to one another. Rather, prevention of removal of the shell from the coupler is achieved entirely through the extension of the receptacle engaging device through the adapter and into the ball-shaped cavity of the trailer coupler receptacle when the lock is in its locked state. This architecture provides several advantages, including ease of adapter exchange, elimination of fastener hardware that may be attacked or corrode, and simplification of the locking and unlocking procedure for the authorized user.

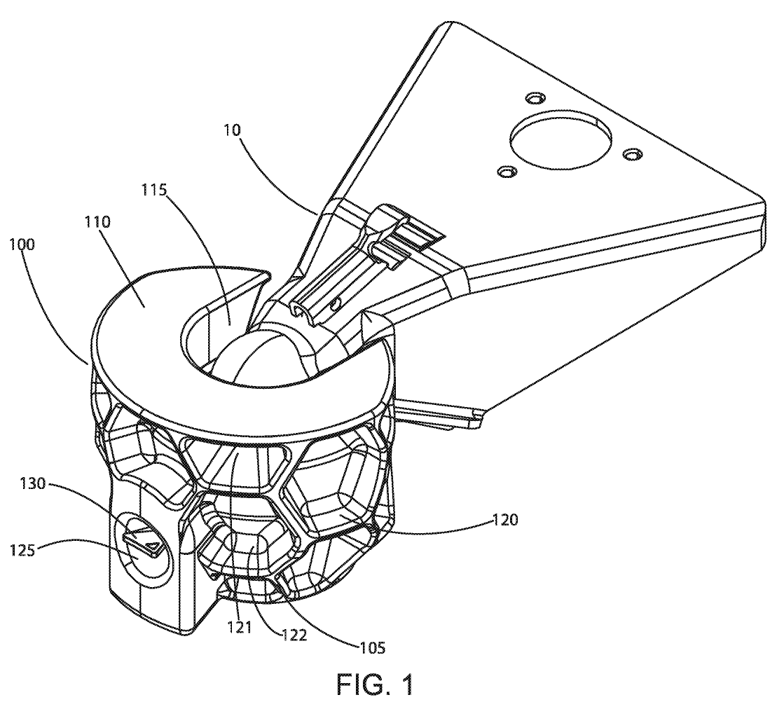

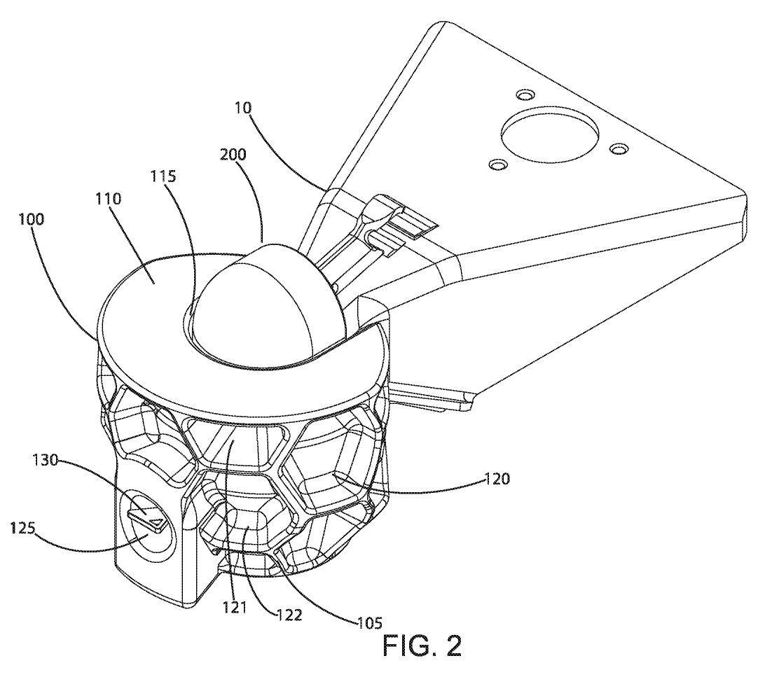

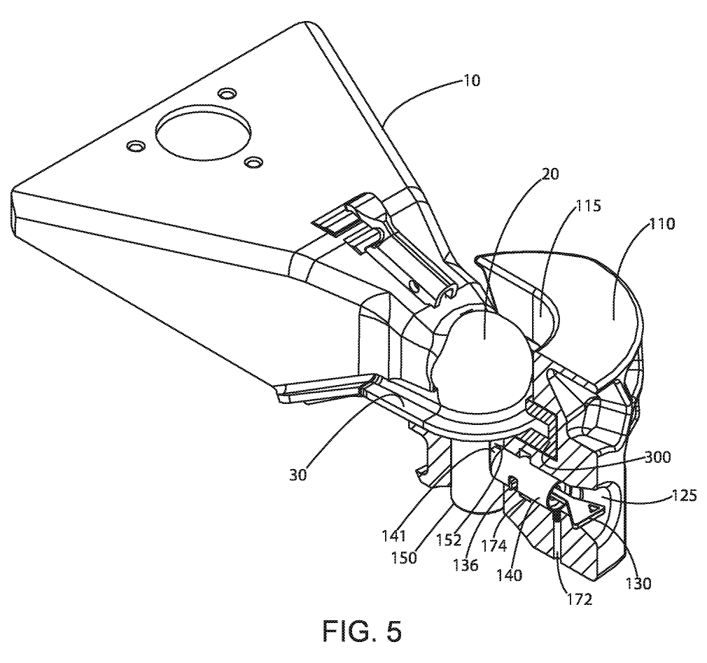

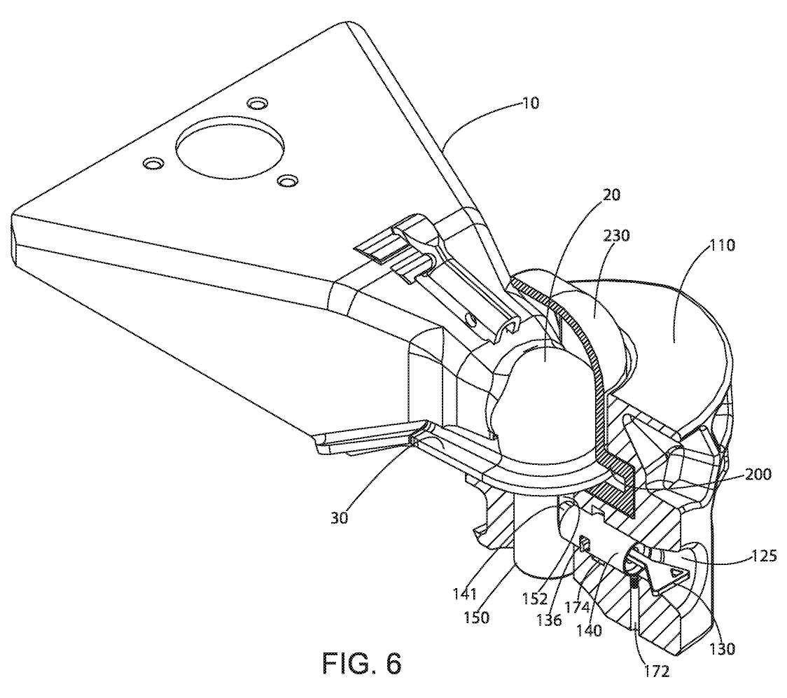

Referring generally to FIGS. 1 through 6, the trailer coupler lock system 100 is shown installed on an exemplary A-frame trailer coupler 10. The A-frame trailer coupler 10 is a ball-and-socket type coupler of the kind commonly employed to connect a trailer to a towing vehicle. The coupler 10 includes a receptacle 20 having a ball-shaped internal socket configured to receive a towing ball mounted on the towing vehicle, and a peripheral flange 30 that projects radially outward from the receptacle 20. While the invention is illustrated in connection with an A-frame trailer coupler, the invention is not so limited. The lock system 100 may be adapted for use with any trailer coupler having a receptacle and a peripheral flange or equivalent structure.

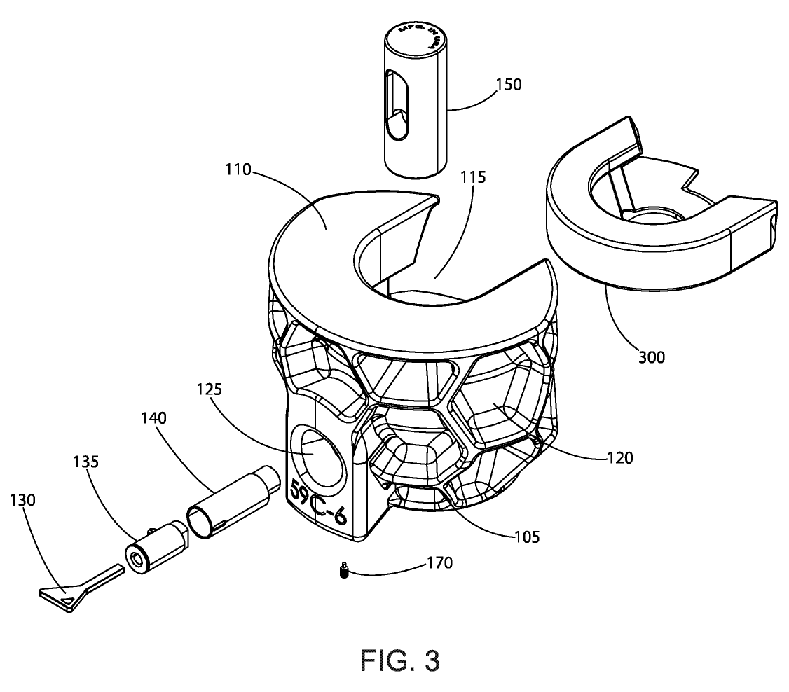

The shell 105, shown in detail in FIGS. 3, 4, 11, and 12, is the primary structural component of the lock system 100. The shell 105 is a rigid, solid-walled housing defining a front face, a back face, a bottom, and a top. The shell 105 may be manufactured from any suitable structural metal or metal alloy, including but not limited to steel alloys, aluminum alloys, or composite materials. In a preferred embodiment, the shell 105 is comprised of an aluminum alloy or other lightweight material to reduce the overall mass of the device while providing adequate structural integrity. The shell 105 may be formed by investment casting, die casting, machining from billet, or any combination of these manufacturing techniques. The shell 105 may be formed as a unitary, integrally formed structure, meaning that it is formed as a single piece rather than as an assembly of separately formed components joined together.

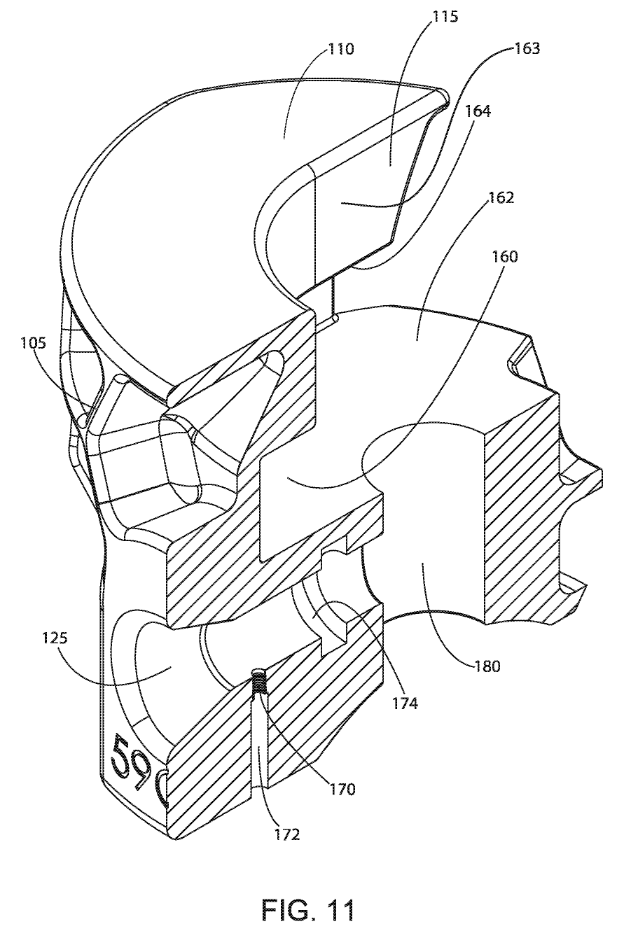

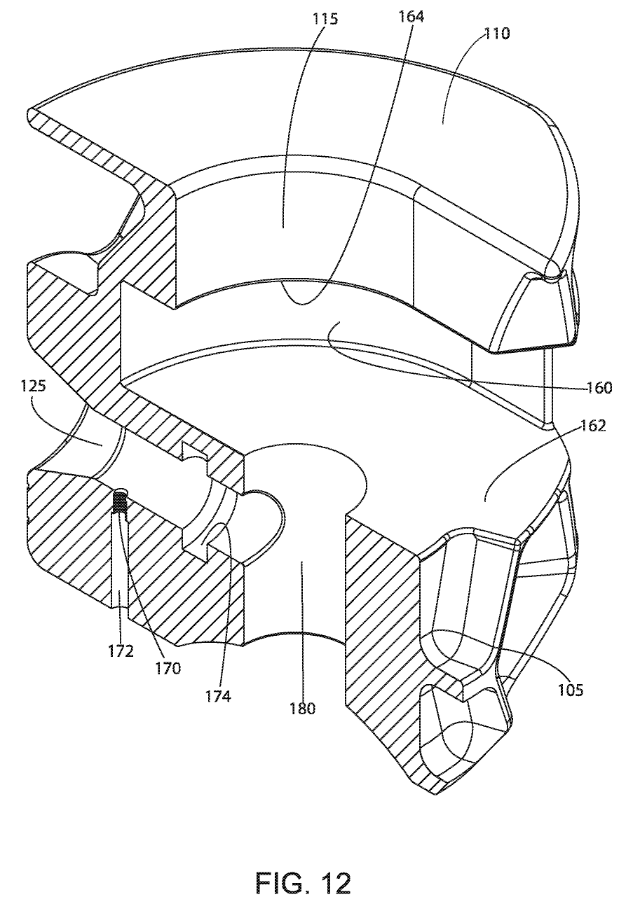

The back face of the shell 105 is formed with a cove 115, which is a concave recess sized and configured to receive the receptacle portion 20 of the trailer coupler 10. The cove 115 may be generally circular or ovoid in cross-section as viewed from the back of the shell, with a diameter and depth sufficient to accommodate the receptacle 20 of the largest coupler size for which the lock system 100 is designed. The cove 115 is bounded by a sidewall 110 that forms the concave inner surface of the recess. As shown in FIGS. 11 and 12, the sidewall 110 terminates at an upper rim 163 that defines the top opening of the cove 115. In the exemplary embodiment illustrated in the figures, the cove 115 is open at the top and closed at the bottom, which allows the lock to be placed over the coupler from above. However, a cove that is covered at both the top and bottom is within the scope of the invention. An adapter engagement slot 160 is formed in the sidewall 110 of the cove 115. The adapter engagement slot 160 is sized and shaped to receive the adapter 200 or 300, as described in detail below. The adapter engagement slot 160 comprises a groove or channel formed in the sidewall of the cove, configured to engage at least a peripheral portion of the adapter when the adapter is slidably received in the slot.

With reference to FIGS. 1, 2, 3, and 4, the exterior surface of the shell 105 includes a bottom portion 121 and a bottom face 122 that define the lowermost extent of the shell body. These bottom structures are shaped and sized to abut the top surface of the trailer coupler when the lock system 100 is installed, providing a stable seating surface and limiting vertical play of the assembled lock on the coupler. The bottom portion 121 and face 122 cooperate with the adapter engagement slot 160 and the receptacle engaging device to form a mechanically stable locked assembly.

A first channel, referred to herein as the plug channel 180, extends from the bottom of the shell 105 upwardly to the cove 115. The plug channel 180 is generally cylindrical in cross-section and defines a vertical axis along which the receptacle engaging device 150 moves linearly between its locked and unlocked positions. The longitudinal axis of the plug channel 180 is substantially orthogonal to the plane of the adapter engagement slot 160, so that the receptacle engaging device 150, when in its locked position, extends upwardly through the plug channel 180, through the hole in the base of the adapter, and into the cove 115 to engage the interior of the receptacle 20 of the coupler 10. A lock channel 125 extends from the front face of the shell 105 to the plug channel 180, intersecting the plug channel 180 at a point above the adapter engagement slot 160. The lock channel 125 and the plug channel 180 are substantially orthogonal to one another. The lock channel 125 houses the bolt mechanism 140 and lock core 135 of the locking assembly, as described in detail below. A locking mechanism within the lock channel 125 is actuated using a key 130, as shown in FIGS. 1 through 6, which is inserted into the front face of the lock system 100.

The exterior surface of the shell 105 is formed with a plurality of hexagonal prism bosses 120 arranged in a honeycomb pattern, as clearly visible in FIGS. 1 through 6 and 17. This distinctive exterior geometry serves both a weight-reduction function and an anti-attack function. The hexagonal prism bosses 120 reduce the mass of the shell 105 compared to a solid shell of equivalent external dimensions, while the lattice-like structure between the bosses maintains structural rigidity. Certain boss cells may be non-hexagonal where space constraints at the periphery of the shell 105 do not accommodate a full hexagonal prism; for example, as shown in FIGS. 1 through 4, a partial cell 121 is formed where there is insufficient space between an adjacent full cell 122 and the top edge of the shell for a complete hexagonal prism. From a security standpoint, the hexagonal prism bosses 120 are configured to defeat angle grinder attacks, which represent a common method of attack on conventional coupler locks. A cutting disc having a diameter of 4.5 inches—the most common size used in portable angle grinders—cannot maintain continuous cutting contact with the exterior surface of the shell 105 because the hexagonal geometry presents at least two angled projecting surfaces that cause the disc to skip, chatter, and lose contact. In a preferred embodiment, the distance between opposite corners of each hexagonal prism boss 120 does not exceed 3 inches, and more preferably is between 2.0 and 2.75 inches, which is a dimension calibrated to optimally defeat a 4.5-inch cutting disc. The shell 105 may further include a lock code indicator stamped or molded into the surface, to facilitate identification of the correct key.

As shown in FIGS. 11 and 12, an annular groove 174 is formed in the wall of the lock channel 125 at a location corresponding to the extended (locked) position of the lock assembly. The annular groove 174 extends 360 degrees around the interior circumference of the lock channel 125. A threaded channel 172 extends from the exterior of the shell 105 to the lock channel 125 and is configured to receive a set screw 170. The set screw 170, when installed, limits the range of linear motion of the bolt mechanism 140 within the lock channel 125. An overhang 164 is formed at the top of the adapter engagement slot 160, abutting and retaining the top flange 215 or 315 of the adapter 200 or 300 when the adapter is received in the slot 160. The bottom surface 162 of the cove 115 provides a seating surface upon which the base of the adapter rests when the adapter is fully installed in the engagement slot 160.

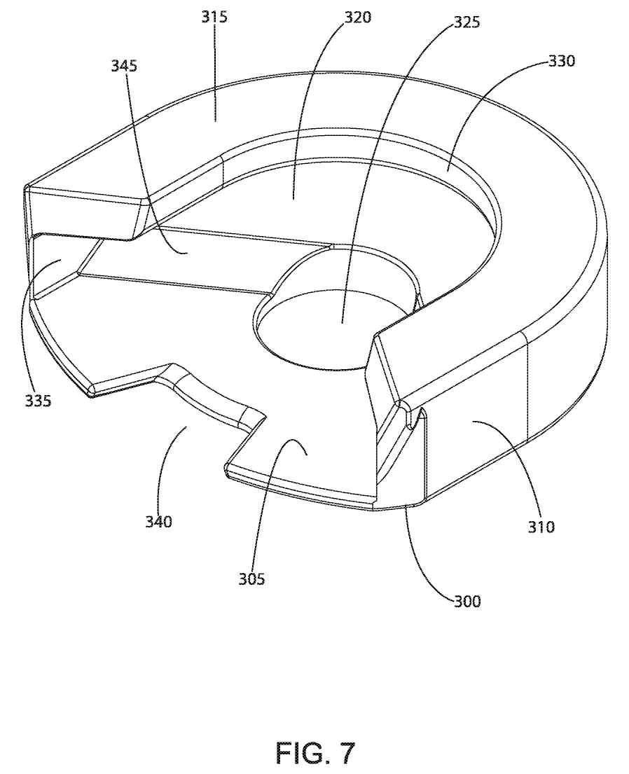

The interchangeable adapter, of which two exemplary embodiments 300 and 200 are illustrated in FIGS. 7-10, is a component that bridges the dimensional and geometric differences between trailer couplers of various sizes and the universal geometry of the shell cove 115. The adapter is configured to be slidably received in the adapter engagement slot 160 of the shell 105 and to receive and engage the peripheral flange 30 of the trailer coupler receptacle 20. A principal distinguishing feature of the present invention, as compared with prior art modular lock designs, is that the adapter does not need to be mechanically fastened to the shell in order to achieve a secure locked assembly. The adapter is held in its operative position within the shell by the engagement of the shell’s adapter engagement slot 160 with the peripheral portions of the adapter, and the assembly as a whole is secured to the coupler by the extension of the receptacle engaging device 150 through the hole in the adapter’s base and into the receptacle 20 of the coupler 10. This arrangement means that an unauthorized person cannot remove the shell from the coupler even if no fasteners are present between the adapter and the shell, because the receptacle engaging device physically blocks removal of both the adapter and the shell. This is a fundamental architectural distinction from prior art systems, including the Altor/Cato modular lock designs, in which adapters are configured to be fastened to the lock body.

The term “adapter” as used herein is broadly construed to include any insert, wear plate, sizing shim, security insert, or other component configured to be received in the adapter engagement slot 160 and to engage the flange 30 of a trailer coupler 10. This broad definition is intended to prevent a competitor from substituting a functionally equivalent component under a different name in order to design around the claims of the present invention. An adapter may be comprised of any suitable material, including but not limited to steel alloys, hardened and tempered steel, aluminum alloys, cast iron, and engineering polymers or composite materials. In a preferred embodiment, the adapter 200 or 300 is comprised of a hardened and tempered steel alloy that is denser and harder than the material comprising the shell 105, providing a harder protective core within a lighter-weight shell. This allows the shell to be manufactured from a less dense material such as an aluminum alloy while still providing high resistance to cutting and prying attack at the coupler engagement interface.

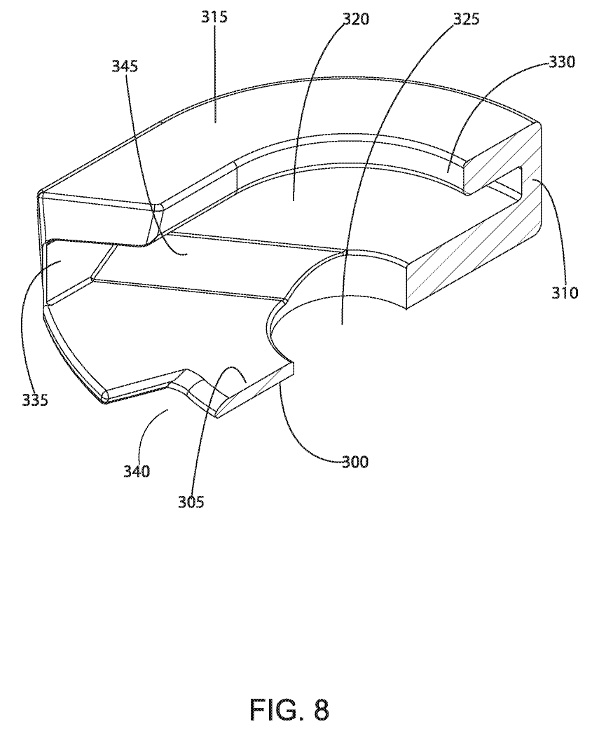

Referring now to FIGS. 7-8, the first exemplary adapter 300 comprises a base 305 that forms the floor of the adapter, a sidewall 310 extending upwardly from the peripheral edge of the base 305, and a flange 315 extending inwardly from the top of the sidewall 310. The sidewall 310 generally describes a U-shape when viewed in plan, and the inwardly directed flange 315 likewise describes a U-shaped opening. The base 305, sidewall 310, and flange 315 collectively define a coupler flange engagement slot 335 configured to receive the peripheral flange 30 of the trailer coupler receptacle 20. The open space 330 defined above the flange 315 within the arc of the sidewall 310 provides clearance for the receptacle portion 20 of the coupler 10 to reside above the base 305 when the lock is engaged. The U-shaped slot 335 is sized so that the flange 30 of the coupler 10 may be slidably inserted into the slot, while the width of the slot constrains movement of the coupler in the lateral and vertical directions once the receptacle engaging device 150 is in its locked position. A hole 325 extends vertically through the base 305. When the adapter 300 is installed in the adapter engagement slot 160 of the shell 105, the hole 325 is concentrically aligned with the plug channel 180, allowing the receptacle engaging device 150 to pass through the hole 325 and extend into the receptacle 20 of the coupler 10 when actuated to the locked position.

The base 305 of the adapter 300 includes an elevated portion 320, an unelevated portion, and a ramp 345 transitioning between the unelevated portion and the elevated portion 320. The elevated portion 320 is located adjacent to the closed front end of the adapter 300, and the unelevated portion is located toward the rear of the adapter. The ramp 345 serves as a force-redirecting surface that guides the peripheral flange 30 of the coupler receptacle 20 upward and onto the elevated portion 320 of the base 305 as the lock system 100 is placed over the coupler 10. By elevating the flange 30 onto the elevated portion 320, the vertical clearance between the flange 30 and the underside of the overhang flange 315 of the adapter 300 is minimized, thereby reducing vertical play and improving the firmness of engagement between the adapter and the coupler. This also provides a security benefit: the reduced clearance eliminates a potential pry-bar purchase point that a thief might otherwise exploit. The ramp 345 additionally serves as a force-redirecting surface that prevents a thief from obtaining a solid pry-bar engagement on the adapter front face.

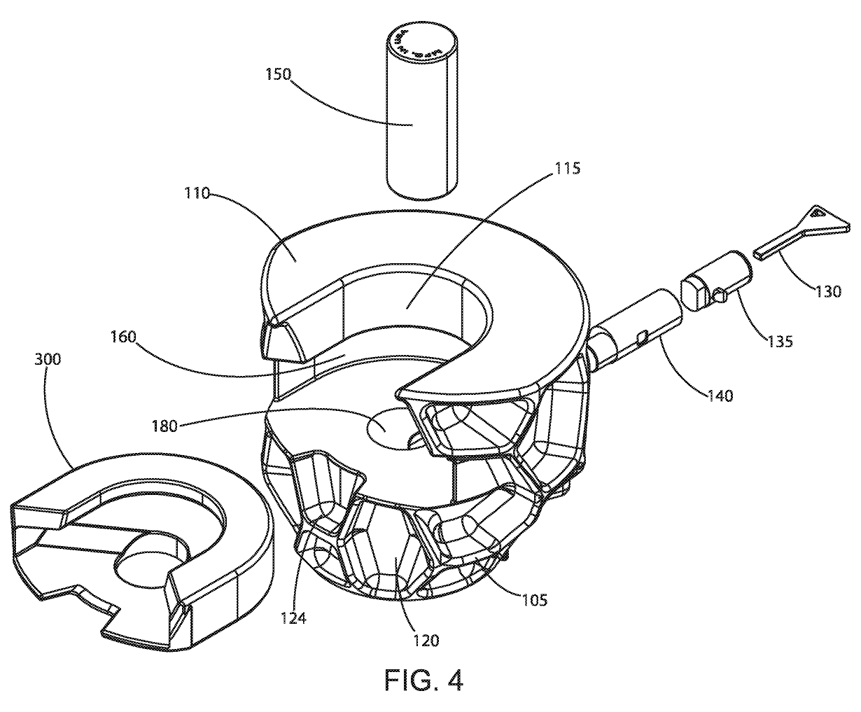

A recess 340 is formed at the front edge of the adapter 300. The recess 340 is configured to conform to the geometry of the underlying structural cell 124 of the shell cove bottom surface 162, as shown in FIG. 4. This prevents the base 305 of the adapter 300 from overhanging the cell 124, eliminating or minimizing any overhang that could serve as a lever point for prying. The base 305 does not extend past the outer edges of the bottom 162 of the cove 115 when the adapter 300 is properly installed.

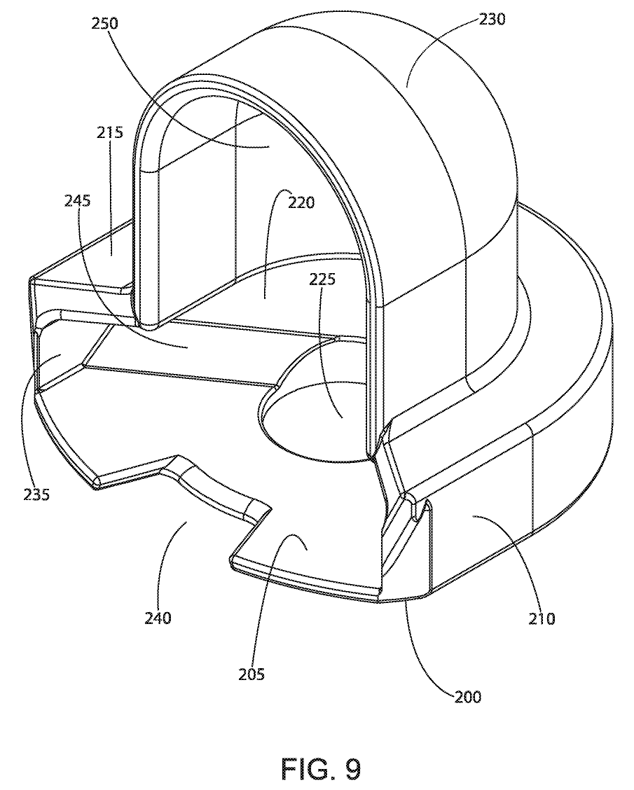

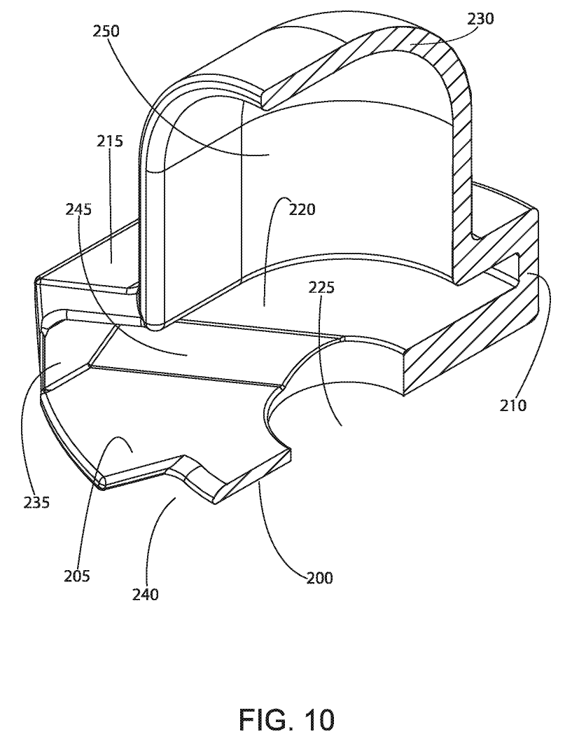

The second exemplary adapter 200, illustrated in FIGS. 9-10, shares the general architecture of the first adapter 300 but additionally includes a cover 230 that extends upwardly from the sidewall 210 of the adapter 200 to envelop and cover the receptacle portion 20 of the trailer coupler 10 when the lock system 100 is engaged. The cover 230 defines a protective space 250 within which the receptacle 20 resides when the lock is locked. The cover 230 protects the receptacle 20 from drilling and from blunt-force attacks directed at dislodging the receptacle engaging device 150 through the receptacle 20. The adapter 200 includes a base 205, a sidewall 210, a flange 215, an elevated portion 220, a hole 225 through the base 205, a slot 235 for engaging the coupler flange 30, a ramp 245, and a recess 240, all corresponding in function to the analogous features of the adapter 300 described above. The front edge of the adapter 200 includes the recess 240 that is configured to conform with the underlying structural cell 124 of the shell cove bottom surface 162, serving the same anti-prying function as the recess 340 of the adapter 300. Both adapters 200 and 300 may optionally be secured to the bottom surface 162 of the cove 115 by one or more mechanical fasteners such as screws. However, the use of fasteners is optional; the lock system 100 functions in its intended secure manner even without fasteners between the adapter and the shell, provided the receptacle engaging device 150 is in its locked position.

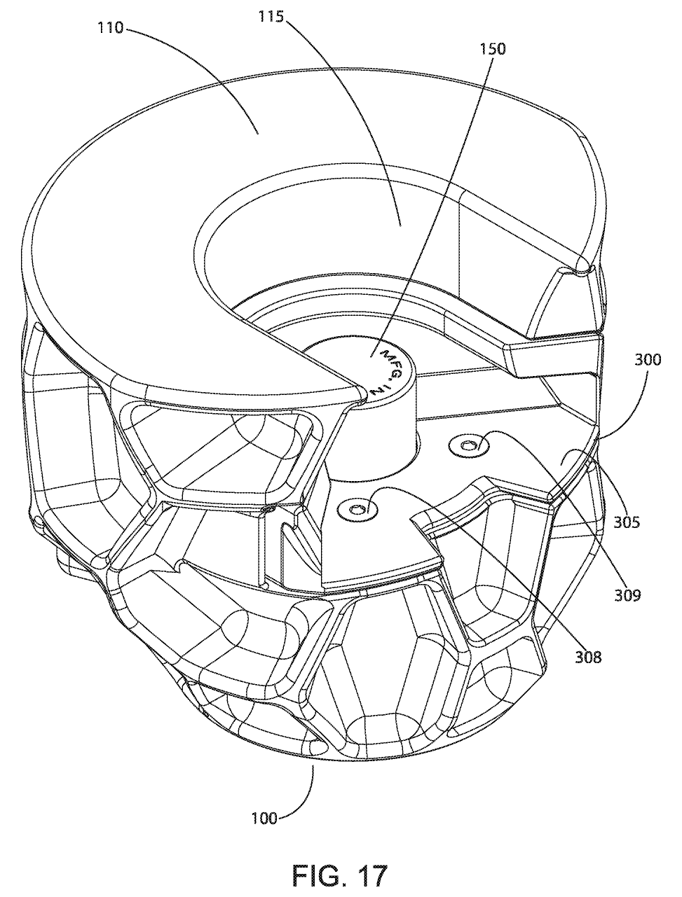

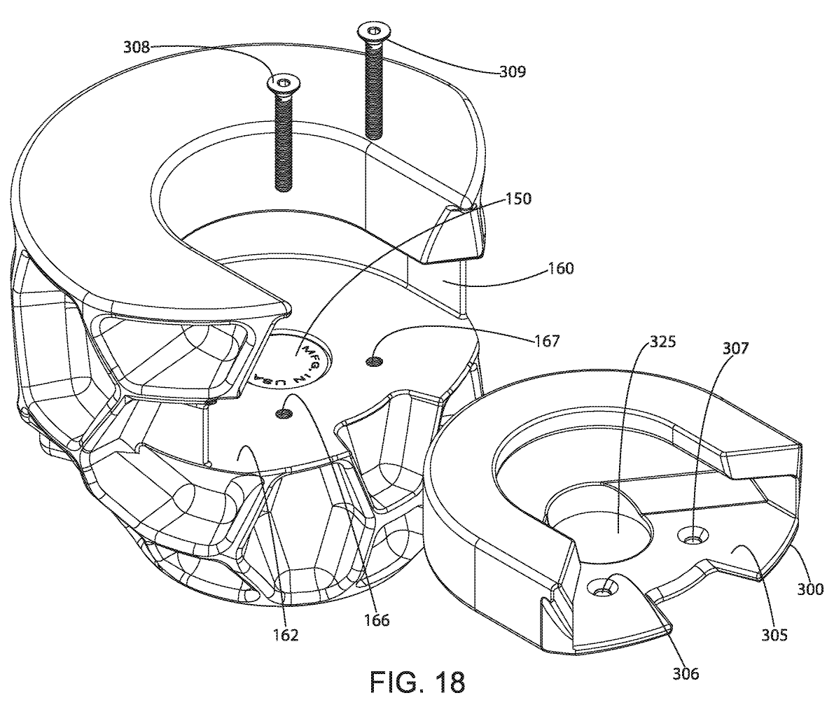

Referring to FIGS. 17 and 18, an optional fastener arrangement is shown in which the adapter 300 includes a pair of through-holes 306 and 307 formed in the base 305 of the adapter. The through-holes 306 and 307 are positioned to align with a corresponding pair of threaded holes 166 and 167 formed in the bottom surface 162 of the cove 115 when the adapter 300 is fully seated in the engagement slot 160. Screws 308 and 309 pass downwardly through the holes 306 and 307 in the adapter base and engage the threaded holes 166 and 167 in the bottom surface 162 of the cove 115, thereby mechanically securing the adapter 300 to the shell 105. When the screws 308 and 309 are installed, they are concealed within the interior of the assembled lock system 100, rendering them inaccessible to unauthorized removal without first unlocking and removing the lock. FIG. 18 shows the adapter 300 removed from the shell 105, with the plug channel 180 exposed, the hole 325 visible in the adapter base 305, and the screws 308 and 309 removed to reveal the threaded holes 166 and 167 in the cove bottom surface 162.

The adapter engagement slot 160 of the shell 105 is configured to receive the adapter 200 or 300 by sliding engagement. When the adapter 200 or 300 is inserted into the slot 160, the base 205 or 305 abuts the bottom surface 162 of the cove 115, and the top of the flange 215 or 315 abuts the overhang 164 of the slot 160. The peripheral engagement of the adapter sidewall 210 or 310 and flange 215 or 315 within the slot 160 prevents the adapter from rotating or moving laterally relative to the shell. The sole pathway by which the adapter may be removed from the shell is by sliding it rearwardly out of the slot 160 in a direction parallel to the bottom surface of the cove. This sliding path is blocked when the coupler 10 is received in the cove 115 and the receptacle engaging device 150 is in the locked position, because the receptacle engaging device 150 physically occupies the hole 225 or 325 in the adapter base and simultaneously engages the interior of the receptacle 20, thereby preventing upward, lateral, or rearward withdrawal of the adapter.

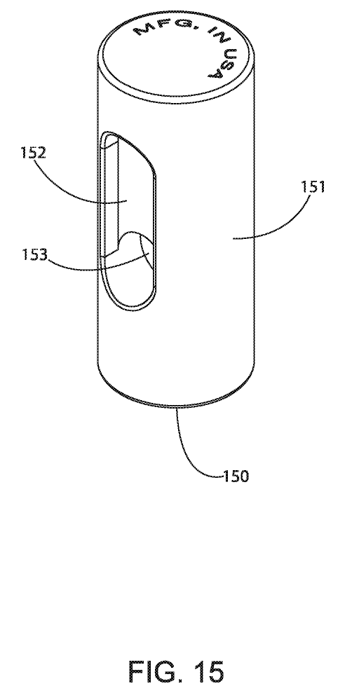

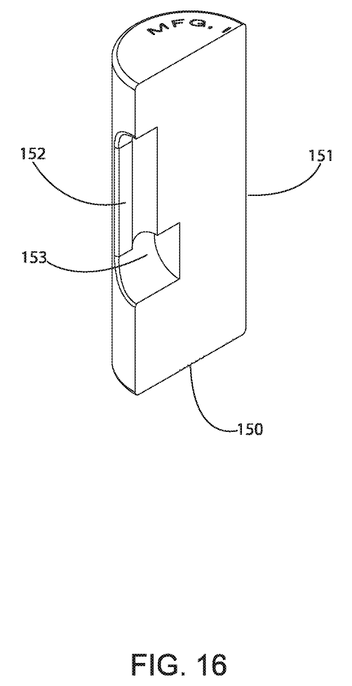

The receptacle engaging device 150 is illustrated in detail in FIGS. 15 and 16. In the exemplary embodiment, the receptacle engaging device 150 is a plug comprising a cylindrical body 151 having a longitudinal axis that is generally parallel to the longitudinal axis of the plug channel 180. The cylindrical body 151 includes an elongated slot 152 formed in its sidewall, with the longitudinal axis of the slot 152 parallel to the longitudinal axis of the cylindrical body 151. The slot 152 includes a top end and a bottom end, and a locking recess 153 is formed in the slot 152 at the bottom end thereof. The locking recess 153 is a circular or semi-circular compartment whose diameter is at least equal to, and preferably slightly greater than, the diameter of the cylindrical bolt 141 of the bolt mechanism 140. The elongated slot 152 allows the cylindrical bolt 141 to travel linearly within the slot 152 as the plug 150 moves between its locked and unlocked positions, while the locking recess 153 defines the locked position of the plug 150 by receiving and retaining the cylindrical bolt 141 when the bolt is extended.

The plug 150 is actuated by gravity. When the bolt 141 is withdrawn from the locking recess 153, the plug 150 descends under the influence of gravity within the plug channel 180 until the cylindrical bolt 141 abuts the top end of the slot 152, which corresponds to the retracted (unlocked) position of the plug 150. In the retracted position, the plug 150 is entirely within the plug channel 180 and does not extend into the cove 115, does not extend through the hole 225 or 325 in the adapter base, and does not engage the receptacle 20 of the coupler 10. This gravity-drop architecture provides a passive unlocking action that does not require any mechanical intervention beyond the retraction of the bolt 141. To lock the device, the authorized user extends the bolt 141, inserts the coupler 10 into the lock system 100 such that the flange 30 is received in the adapter slot 235 or 335 and the receptacle 20 is positioned in the cove 115, and then allows the plug 150 to drop under gravity into the locked position with the plug 150 extending through the adapter base hole 225 or 325 and into the ball-shaped internal cavity of the receptacle 20. The authorized user then uses a key 130 to retract the bolt 141 slightly into alignment with the slot 152 and then, by reinserting the bolt 141, secures the plug 150 in the locked position by engaging the locking recess 153.

To exchange the adapter 200 or 300 when the gravity-actuated plug 150 is employed as the receptacle engaging device, the following sequence is used. The authorized user inserts the key 130 into the lock core 135 and rotates it to the unlocked position, causing the lug 136 to retract from the annular groove 174 and permitting the bolt mechanism 140 to slide linearly outward within the lock channel 125. Linear travel of the bolt mechanism 140 is initially limited by the set screw 170 engaging the fenestration 145 of the sleeve 143; this partial retraction of the bolt 141 from the locking recess 153 allows the plug 150 to descend by gravity within the plug channel 180 until the bolt 141 bears against the top end of the elongated slot 152, arresting downward travel of the plug 150. The user then loosens the set screw 170 and slides the sleeve 143 further outward, fully withdrawing the cylindrical bolt 141 from the elongated slot 152 of the plug 150. With the bolt 141 fully retracted from the plug channel 180, the plug 150 is no longer captive in the plug channel 180 and may be removed downwardly from the shell 105. The adapter 200 or 300 may then be slid rearwardly out of the engagement slot 160. A replacement adapter is installed by reversing these steps: the new adapter is slid into the engagement slot 160, the plug 150 is reinserted into the plug channel 180, the sleeve 143 is advanced to reintroduce the bolt 141 into the elongated slot 152, and the set screw 170 is tightened. While fully functional, this adapter exchange procedure requires the use of tools and multiple sequential steps, making it less convenient in field conditions.

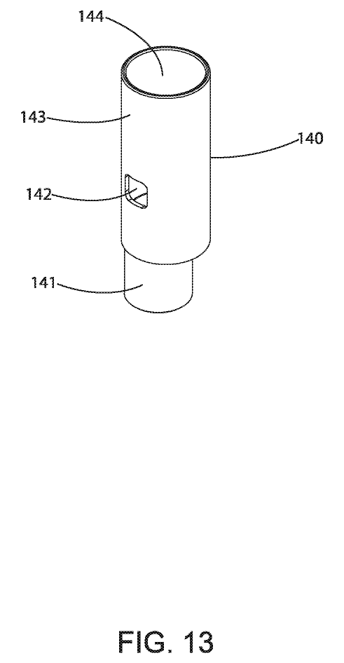

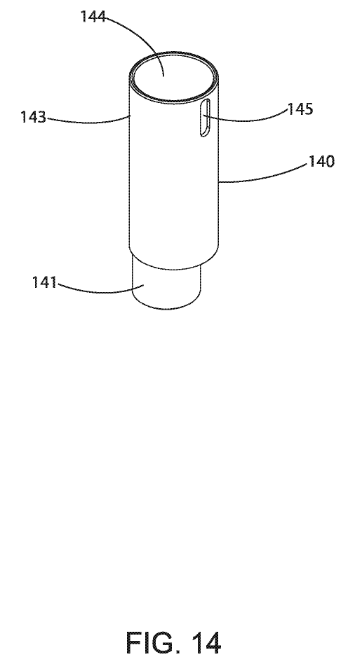

The locking assembly, comprising the bolt mechanism 140, lock core 135, and set screw 170, is housed within the lock channel 125 of the shell 105. As shown in FIGS. 13 and 14, the bolt mechanism 140 includes a sleeve 143 defining a cylindrical interior space 144. The lock core 135 is received within the cylindrical interior space 144. The lock core 135 is a vending-style lock or equivalent key-operated lock core that includes a rotatable cam or lug 136. The sleeve 143 includes a window 142 through which the lug 136 may extend. When the lock core 135 is in its locked rotational position, the lug 136 extends through the window 142 and into the annular groove 174 formed in the wall of the lock channel 125. The annular groove 174 extends 360 degrees around the lock channel, so that rotation of the lock core 135 does not stress the lug 136. When the lug 136 is received in the annular groove 174, appreciable linear motion of the locking assembly within the lock channel 125 is prevented, even if the set screw 170 is removed. The set screw 170 provides an additional limit on linear motion of the locking assembly. A narrow peripheral fenestration 145 formed in the sleeve 143 receives the tip of the set screw 170, and the length of the fenestration 145 defines the permissible range of linear travel of the locking assembly within the lock channel 125.

The cylindrical bolt 141 of the bolt mechanism 140 extends from the end of the sleeve 143 and is configured to extend into the lock compartment formed at the intersection of the lock channel 125 and the plug channel 180. In the locked configuration, the cylindrical bolt 141 extends into and engages the locking recess 153 at the bottom end of the slot 152 of the plug 150. This engagement positively retains the plug 150 in the extended (locked) position, preventing the plug 150 from descending due to gravity. In the unlocked configuration, the cylindrical bolt 141 is withdrawn from the locking recess 153 but remains within the elongated slot 152, allowing the plug 150 to descend by gravity to the retracted position while the cylindrical bolt 141 slides along the slot 152.

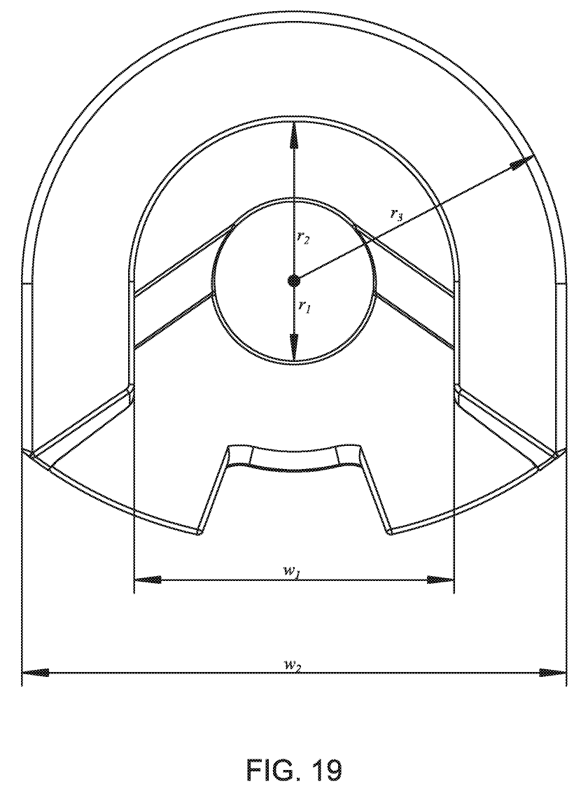

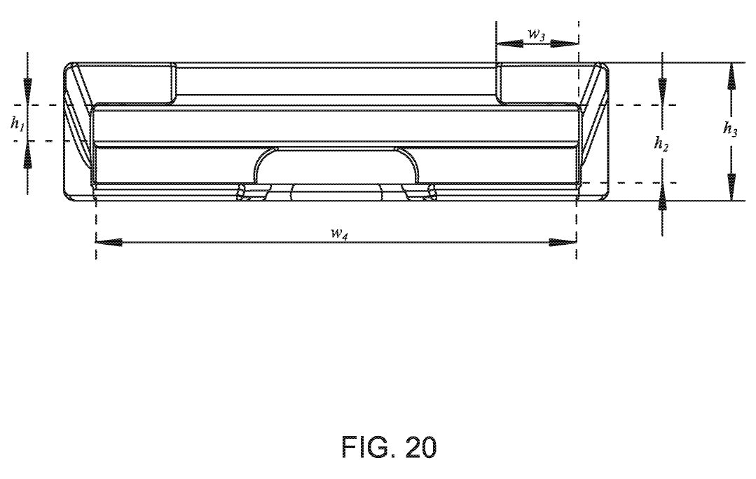

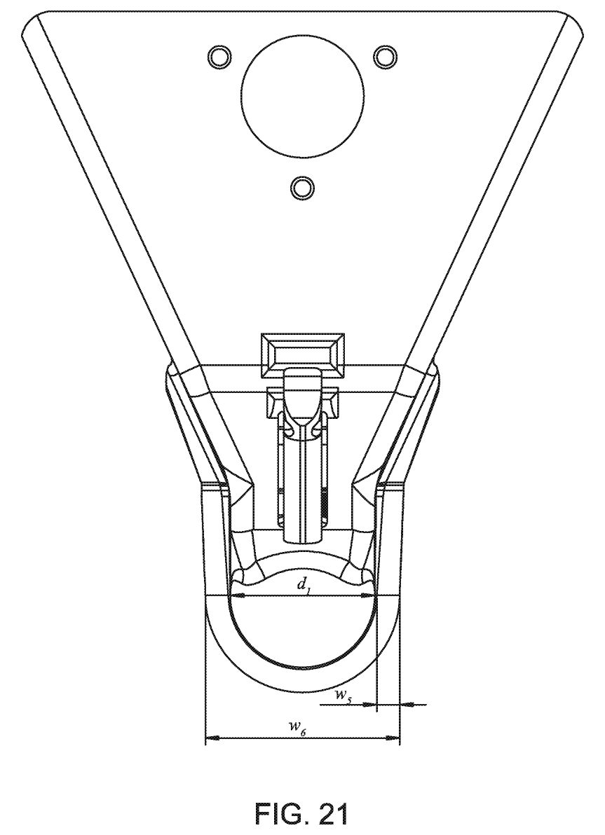

As shown in FIGS. 19 and 20, the adapter 300 has dimensional characteristics that are selected to correspond to the dimensions of the trailer coupler with which it is intended to be used. The radius r1 of the hole 325 through the base 305 slightly exceeds the radius of the plug 150, so that the plug 150 may pass through the hole 325 without appreciable resistance. The radius r2 is measured from the center of the hole 325 to the inner edge of the flange 315, and the outer radius r3 is the overall outer radius of the adapter 300. The width w1 between the opposed inner edges of the flange 315 exceeds the outer diameter of the receptacle 20 of the coupler 10, and the overall width w2 of the adapter 300 exceeds the width of the coupler at the receptacle. As shown in FIGS. 20 and 21, the height h1 from the elevated portion 320 of the base 305 to the underside of the flange 315 is slightly greater than the thickness t of the coupler flange 30, permitting the flange 30 to be received in the slot 335 with minimal clearance. The height h2 from the unelevated portion of the base 305 to the underside of the flange 315 is less than h1, defining the ramp transition. The overall height h3 of the adapter 300, the slot width w3, and the total slot width w4 are sized to correspond to the geometry of the adapter engagement slot 160 of the shell 105.

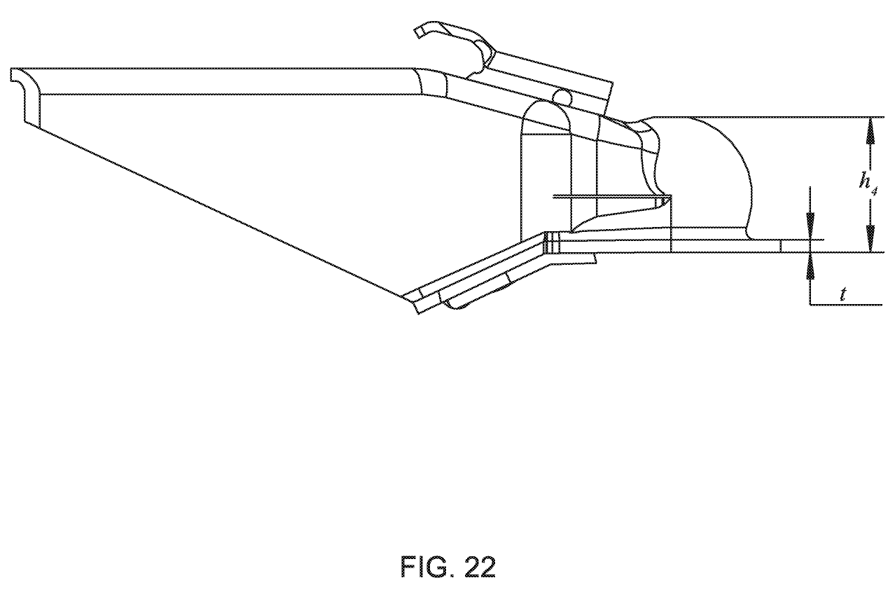

As shown in FIGS. 21 and 22, the receptacle 20 of the coupler 10 has an outer diameter d1 that is greater than the diameter of the hitch ball it is configured to receive. Common ball diameters are 1-7/8 inch, 2 inch, 2-5/16 inch, and 3 inch. The flange 30 of the coupler 10 has a width w5 and the overall width of the coupler at the receptacle is w6, which is approximately the sum of the outer diameter d1 and twice the flange width w5. The height h4 of the coupler receptacle 20 is relevant to the design of the cover 230 of the second adapter 200, as the cover 230 must define a space 250 of sufficient height to receive the receptacle 20. These dimensional relationships are described in further detail in parent Application No. 18/465,104, which is incorporated herein by reference.

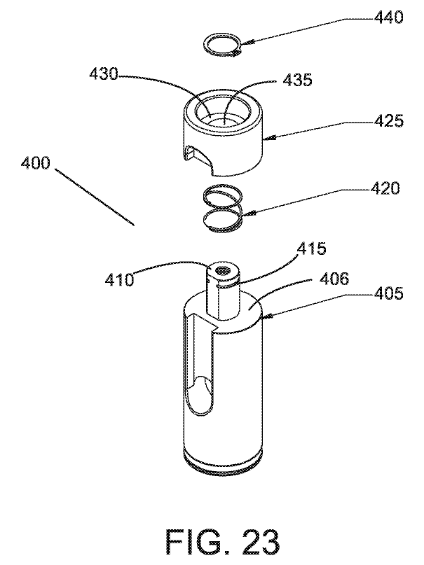

In one embodiment, the receptacle engaging device is a spring-biased pin assembly 400, as conceptually illustrated in FIG. 23. The spring-biased pin assembly 400 provides an alternative to the gravity-actuated plug 150 described above and may be substituted for the plug 150 in any of the embodiments described herein. Both the gravity-actuated plug 150 and the spring-biased pin assembly 400 require key actuation to transition the locking bolt from the locked state to the unlocked state before adapter exchange can be performed. The principal advantage of the spring-biased pin assembly 400 over the gravity-actuated plug 150 is that, once the locking bolt has been retracted by key actuation to its initial unlocked travel limit defined by the set screw 170, the adapter can be removed and replaced by simple digital depression of the spring-biased cap 425 without any further use of tools, without loosening of the set screw 170, and without removing the spring-biased pin assembly 400 from the plug channel 180. By contrast, adapter exchange using the gravity-actuated plug 150 requires the additional steps of loosening the set screw 170, fully withdrawing the sleeve 143, and physically extracting the plug 150 from the plug channel 180 before the adapter can be slid free. The spring-biased pin assembly 400 thereby significantly streamlines the adapter exchange procedure.

With reference to FIG. 23, the spring-biased pin assembly 400 includes a pin body 405. A coaxial neck 410 extends longitudinally from one end of the pin body 405, with that end of the pin body 405 defining an annular shoulder 406 where the pin body 405 transitions to the reduced-diameter neck 410. The neck 410 has an outer diameter that is appreciably less than the outer diameter of the pin body 405. An external annular groove 415 is formed in the neck 410 near its distal end. A coiled compression spring 420 is slidably received over the neck 410 and has an inner diameter greater than the outer diameter of the neck 410, so that the spring 420 may slide freely over the neck 410 without binding. A cap 425 is fitted over the neck 410 and spring 420. The cap 425 is a tubular structure having an inner diameter greater than the outer diameter of the neck 410 and greater than the outer diameter of the spring 420, so that the cap 425 may slide over both the neck 410 and the spring 420. The outer diameter of the cap 425 is approximately equal to the outer diameter of the pin body 405, so that the assembled spring-biased pin assembly 400 presents a substantially uniform outer profile and may be slidably received in the plug channel 180 of the shell 105.

As further shown in FIG. 23, an annular flange 430 is formed within the interior of the tubular cap 425, located between the two ends of the cap 425. The annular flange 430 defines a central opening 435 whose diameter is sufficient to allow the distal end of the neck 410 to extend therethrough but is less than the outer diameter of the coiled compression spring 420. Accordingly, the coiled compression spring 420 cannot pass through the central opening 435 and is retained within the cap 425 between the underside of the annular flange 430 and the shoulder 406 of the pin body 405. A snap ring 440 is seated in the external annular groove 415 of the neck 410 on the side of the annular flange 430 opposite the spring 420, that is, on the distal side of the annular flange 430. The outer diameter of the snap ring 440 when seated in the annular groove 415 exceeds the diameter of the central opening 435, so that the snap ring 440 cannot pass through the central opening 435 and thereby retains the cap 425 on the neck 410 against the force of the spring 420.

In the undeflected state of the spring-biased pin assembly 400, the coiled compression spring 420 urges the cap 425 axially away from the shoulder 406, with the annular flange 430 abutting the snap ring 440 seated in the annular groove 415. In this configuration the assembly 400 is at its full length, representing the maximum axial separation between the shoulder 406 and the distal end of the cap 425. When a sufficient compressive force is applied to the cap 425 directed axially toward the shoulder 406, the cap 425 slides over the neck 410, compressing the spring 420, until the cap 425 abuts the shoulder 406. In this configuration the assembly 400 is at its compressed length. The difference between the full length and the compressed length defines the range of travel of the spring-biased cap 425 relative to the pin body 405.

When the spring-biased pin assembly 400 is installed in the plug channel 180 and is in the unlocked, lowered position—that is, after the key 130 has been used to retract the lug 136 from the annular groove 174 and the bolt mechanism 140 has been slid partially outward to release the locking recess 153, allowing the assembly 400 to descend within the plug channel 180 under gravity until the bolt 141 bears against the top of the elongated slot 152—the cap 425 protrudes upwardly from the plug channel 180 and physically occupies the hole 225 or 325 in the adapter base 205 or 305. The spring force of the coiled compression spring 420 maintains the cap 425 in the full-length position, keeping the cap 425 seated in the hole 225 or 325. It is important to note that in this state the spring-biased pin assembly 400 has descended within the plug channel 180 to the same lowered position that the gravity-actuated plug 150 occupies in its unlocked state; the cap 425 protrudes upward into the adapter hole 225 or 325 but the pin body 405 does not extend into the cove 115 or the coupler receptacle 20. The spring-biased pin assembly 400 must be in this unlocked, lowered state before adapter exchange can be performed; while the assembly 400 is in the locked, elevated position retaining the bolt 141 in the locking recess, the cap 425 and a portion of the pin body 405 are fully extended into the receptacle 20 of the coupler 10 and the adapter cannot be removed.

To exchange the adapter 200 or 300 when the spring-biased pin assembly 400 is employed as the receptacle engaging device, the following sequence is used. The authorized user inserts the key 130 into the lock core 135 and rotates it to the unlocked position, causing the lug 136 to retract from the annular groove 174. The user then slides the sleeve 143 outward within the lock channel 125; travel of the sleeve 143 is limited by the set screw 170 engaging the fenestration 145. This partial outward travel of the sleeve 143 withdraws the cylindrical bolt 141 from the locking recess 153, causing the spring-biased pin assembly 400 to descend by gravity within the plug channel 180 until the bolt 141 bears against the top of the elongated slot 152, arresting the descent. At this point, the cap 425 is in the full-length position and occupies the hole 225 or 325 in the adapter base. The user then applies digital pressure to the top of the cap 425, depressing it toward the shoulder 406 and compressing the spring 420 until the assembly 400 reaches its compressed length, at which point the cap 425 has receded fully into the plug channel 180 and no longer occupies the hole 225 or 325. With the cap 425 depressed, the adapter 200 or 300 may be slid rearwardly out of the engagement slot 160. As the adapter is partially withdrawn, the solid portion of the base 205 or 305 moves over the opening of the plug channel 180, and this solid material bears against the cap 425 and maintains the spring 420 in its compressed state, so that the user need not maintain continuous finger pressure during the sliding motion. The assembly 400 remains at compressed length until the adapter 200 or 300 is either fully withdrawn to expose the plug channel 180, at which point the spring 420 returns the cap 425 to the full-length position, or is slid back into position with the hole 225 or 325 aligned with the plug channel 180, at which point the spring 420 likewise returns the cap 425 to the full-length position. When installing a replacement adapter 200 or 300, the user slides the new adapter into the engagement slot 160 until the hole 225 or 325 in the adapter base approaches alignment with the plug channel 180, depresses the cap 425 with a finger to permit the base to pass over the plug channel opening, and then releases the cap 425 once the hole 225 or 325 is aligned with the plug channel 180, allowing the spring 420 to return the cap 425 to the full-length position seated in the hole 225 or 325. At no pointduring this adapter exchange procedure is it necessary to loosen the set screw 170, slide the sleeve 143 beyond its initial travel limit, or remove the spring-biased pin assembly 400 from the plug channel 180.

When the spring-biased pin assembly 400 is in the locked position—that is, when the lock assembly retains the assembly 400 in the fully elevated position within the plug channel 180 with the bolt 141 engaged in the locking recess—the cap 425, the neck 410, and a portion of the pin body 405 extend through the hole 225 or 325 of the adapter base and into the receptacle 20 of the coupler 10. In this locked state, the spring-biased pin assembly 400 prevents a towing ball from being inserted into the receptacle 20, and simultaneously prevents the adapter 200 or 300 from being removed from the adapter engagement slot 160, in the same manner as the gravity-actuated plug 150 described above. The cap 425, being of approximately the same outer diameter as the pin body 405 and constructed of a structural metal, presents a hard, substantially solid face to the interior of the receptacle 20, providing a robust and tamper-resistant engagement.

The exterior surface of the shell 105 may optionally include markings, indicia, logos, codes, or other ornamental or informational features imprinted, inscribed, painted, or otherwise applied to the surface. A lock code indicator stamped into the exterior surface may be used to identify the correct key profile for the lock core 135, facilitating key duplication by the owner without requiring possession of the original key.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A trailer coupler lock comprising:
a shell, the shell including a front, a back, a bottom and a top,
a cove formed in the back of the shell, the cove comprising a concave recess into which a receptacle portion of a coupler may be received,
an adapter engagement slot formed in the back of the shell at the cove, and
a first channel extending from the bottom of the shell to the cove; and
an adapter removably received in the adapter engagement slot,
the adapter including a base and a coupler flange engagement slot; and
a receptacle engaging device, the receptacle engaging device being movable in the first channel from an unlocked position to a locked position, and in the locked position extending into a ball-shaped cavity on the bottom of the coupler receptacle, thereby preventing the shell and adapter from being removed from the coupler, and in the unlocked position the receptacle engaging device not extending into the cove;
wherein the adapter and the shell are not required to be mechanically fastened to one another, and the prevention of removal of the shell from the coupler is achieved through the cooperative engagement of the shell, the adapter, and the receptacle engaging device with the coupler.

2. The trailer coupler lock of claim 1, the cove including a sidewall, and the adapter engagement slot comprising a groove formed in the sidewall of the cove, the groove being configured to engage at least a portion of the adapter at a periphery of the adapter.

3. The trailer coupler lock of claim 2, the cove including a bottom surface, and the base of the adapter abutting the bottom surface of the cove when the adapter is received in the adapter engagement slot, and an overhang formed above the adapter engagement slot abutting a top surface of a flange of the adapter.

4. The trailer coupler lock of claim 1, the adapter further comprising a sidewall extending upwardly from the base and a flange extending inwardly from the sidewall, the base, sidewall and flange defining the coupler flange engagement slot configured to receive a peripheral flange of the coupler receptacle.

5. The trailer coupler lock of claim 4, the base of the adapter including an elevated portion adjacent to a front end of the base, an unelevated portion adjacent to a rear end of the base, and a ramp transitioning from the unelevated portion to the elevated portion, the ramp being configured to guide a peripheral flange of the coupler receptacle onto the elevated portion.

6. The trailer coupler lock of claim 1, the adapter further comprising a cover extending from the adapter configured to envelop the receptacle portion of the coupler when the lock is in the locked position.

7. The trailer coupler lock of claim 1, wherein the receptacle engaging device is a spring-biased pin assembly comprising a pin body, a coaxial neck extending longitudinally from a shoulder of the pin body, a coiled compression spring disposed coaxially over the neck, a tubular cap slidably received over the neck and spring, the cap including an internal annular flange defining a central opening through which a distal end of the neck extends, and a snap ring engaged in an external annular groove formed in the neck on a side of the internal annular flange opposite the spring, wherein the spring urges the cap to a full-length position in which the cap occupies a hole in the base of the adapter when the receptacle engaging device is in the unlocked position, and wherein, after key actuation has placed the receptacle engaging device in the unlocked position, digital depression of the cap toward the shoulder to a compressed length withdraws the cap from the hole and permits removal of the adapter without tools and without removal of the spring-biased pin assembly from the first channel.

8. A trailer coupler lock comprising:
a shell defining a coupler receiving cove and a vertical plug channel extending from a bottom of the shell to the cove;
a plug movable within the vertical plug channel between a locked position in which a portion of the plug extends into the cove and an unlocked position in which the plug is retracted from the cove;
the plug comprising a cylindrical body having a sidewall defining a longitudinal slot with a locking recess formed at a lower end of the longitudinal slot; and
a locking assembly movably received in a lock channel of the shell that intersects the plug channel, the locking assembly comprising a retractable cylindrical bolt;
wherein in a locked state, the cylindrical bolt engages the locking recess at the lower end of the longitudinal slot to suspend the plug in the locked position; and
wherein in an unlocked state, the cylindrical bolt disengages the locking recess and is received in the longitudinal slot, permitting the plug to descend by gravity within the plug channel to the unlocked position while the longitudinal slot guides travel of the cylindrical bolt.

9. The trailer coupler lock of claim 8, the locking assembly further comprising a sleeve defining a cylindrical compartment in which a lock core is received, the sleeve including a window, and the lock core including a lug that extends through the window when the lock core is in a locked rotational position.

10. The trailer coupler lock of claim 9, an annular groove formed in a wall of the lock channel, the lug extending into the annular groove when the lock core is in the locked rotational position, thereby preventing linear motion of the locking assembly within the lock channel.

11. The trailer coupler lock of claim 10, the annular groove extending 360 degrees around an interior circumference of the lock channel, whereby rotation of the lock core does not stress the lug when the lug is received in the annular groove.

12. The trailer coupler lock of claim 8, a set screw received in a threaded channel extending from an exterior of the shell to the lock channel, the set screw engaging a peripheral fenestration formed in a sleeve of the locking assembly to limit linear travel of the locking assembly within the lock channel.

13. The trailer coupler lock of claim 8, further comprising an interchangeable adapter removably received in an adapter engagement slot formed in the cove of the shell, the adapter including a base with a hole concentrically aligned with the plug channel, wherein in the locked position the plug extends through the hole and into the coupler receiving cove, and in the unlocked position the plug does not extend through the hole.

14. The trailer coupler lock of claim 8, the shell including an exterior surface formed with a plurality of hexagonal prism bosses arranged in a honeycomb pattern, a distance between opposite corners of each hexagonal prism boss not exceeding 3 inches.

15. A security device for a trailer coupler comprising:
a unitary shell body defining a central cavity configured to receive a receptacle portion of a trailer coupler;
the shell body comprising an exterior surface formed with a plurality of contiguous hexagonal prism bosses arranged in a honeycomb pattern;
wherein a distance between opposite corners of each hexagonal prism boss is between 2.0 and 2.75 inches; and
wherein each hexagonal prism boss extends from a core of the shell body by a depth sufficient to present at least two angled projecting surfaces to a tangential cutting disc having a diameter of 4.5 inches, thereby preventing the cutting disc from maintaining continuous cutting contact with the exterior surface of the shell body.

16. The security device of claim 15, the shell body further defining an adapter engagement slot in the central cavity, an adapter removably received in the adapter engagement slot, the adapter comprising a base, a sidewall extending from the base, and a flange extending inwardly from the sidewall, the base, sidewall and flange defining a slot configured to receive a peripheral flange of the trailer coupler receptacle.

17. The security device of claim 16, the adapter comprising a base with a hole, and a plug channel extending from a bottom of the shell body to the central cavity and concentrically aligned with the hole, and a plug movable within the plug channel from a locked position in which the plug extends through the hole into the central cavity to a retracted position in which the plug does not extend through the hole.

18. The security device of claim 17, wherein the receptacle engaging device is a spring-biased pin assembly comprising a pin body, a coaxial neck extending from a shoulder of the pin body, a coiled compression spring disposed coaxially over the neck, a tubular cap slidably received over the neck, an internal annular flange formed within the cap and defining a central opening through which a distal end of the neck extends, and a snap ring engaged in an external annular groove in the neck to retain the cap, wherein in an undeflected state the spring maintains the cap at a full-length position in which the cap occupies the hole in the adapter base when the spring-biased pin assembly is in the unlocked position, and wherein, after key actuation has placed the spring-biased pin assembly in the unlocked position, digital depression of the cap compresses the spring to a compressed length and withdraws the cap from the hole to permit adapter removal without tools and without removal of the spring-biased pin assembly from the plug channel.

19. The security device of claim 15, the shell body being comprised of a first material and the adapter being comprised of a second material different from the first material, a density of the second material being greater than a density of the first material, and a hardness of the second material being greater than a hardness of the first material.

20. The security device of claim 15, the shell body further comprising a lock channel intersecting a plug channel, a locking assembly movable in the lock channel between a locked configuration and an unlocked configuration, an annular groove formed in a wall of the lock channel, and a lug on a lock core of the locking assembly that extends into the annular groove in the locked configuration to prevent linear motion of the locking assembly.
